(19) United States
(12) Patent Application Publication
(10) Pub. No.: US 2026/0092845 A1
(43) Pub. Date: Apr. 2, 2026

(54) MATERIAL TESTING MACHINE AND CONTROL METHOD FOR MATERIAL TESTING MACHINE

(71) Applicant: SHIMADZU CORPORATION, Kyoto-shi (JP)

(72) Inventor: Daisuke HAGIHARA, Kyoto-shi (JP)

(21) Appl. No.: 19/339,905

(22) Filed: Sep. 25, 2025

(30) Foreign Application Priority Data
Sep. 27, 2024 (JP) 2024-169438

(51) Int. Cl. G01N 3/10; G01N 3/06

(52) U.S. Cl. CPC G01N 3/10; G01N 3/066

(57) ABSTRACT

A fatigue testing machine is a fatigue testing machine that executes a fatigue test for measuring a mechanical property of a test piece by applying a test force to the test piece, the fatigue testing machine comprising: a hydraulic actuator that applies a test force to the test piece; a generation unit that generates a sinusoidal input waveform indicating a test force target value, which is a target value of the test force; a detection unit that detects the test force applied to the test piece by the hydraulic actuator; and a calculation unit that calculates a distortion rate of an output waveform indicating a detection result of the detection unit during execution of the fatigue test.

### INCORPORATION BY REFERENCE

The present application claims priority under 35 U.S.C. § 119 to Japanese Patent Application No. 2024-169438 filed on Sep. 27, 2024. The content of this application is incorporated herein by reference in its entirety.

### TECHNICAL FIELD

The present invention relates to a material testing machine and a control method for a material testing machine.

### BACKGROUND ART

Conventionally, various techniques related to testing machine characteristics are known for material testing machines such as fatigue testing machines. For example, Patent Literature 1 discloses a testing machine characteristic evaluation method that includes an experiment execution step of changing the frequency of displacement applied to a test piece of a fatigue testing machine to determine the relationship between frequency and the amplitude corresponding to the displacement, and a curve approximation step of calculating at least one of a maximum velocity curve and a maximum acceleration curve that approximates the relationship between frequency and amplitude. The maximum velocity curve indicates a curve where the maximum velocity corresponding to the displacement is constant, and the maximum acceleration curve indicates a curve where the maximum acceleration corresponding to the displacement is constant.

### PRIOR ART DOCUMENTS

### Patent Literature

[Patent Literature 1] Japanese Unexamined Patent Application Publication No. 2022-134709

### SUMMARY OF INVENTION

### Problem to be Solved by the Invention

However, in conventional fatigue testing machines such as the one described in Patent Literature 1, although a delay (phase difference) occurs between the input waveform and the output waveform, it can only be confirmed visually, and it has been difficult to compare the waveform shape of the output waveform with the waveform shape of the input waveform during the execution of a fatigue test.

Furthermore, for example, during the execution of a fatigue test, it has not been possible to confirm whether the degree of deviation of the output waveform from an ideal state falls within a range desired by the user.

The present invention has been made in view of such circumstances, and an object thereof is to provide a material testing machine and a display control method for a material testing machine that enable a user to quantitatively grasp the degree of deviation of an output waveform from a sine wave (=corresponding to an example of an ideal state) during the execution of a material test.

### Means for Solving the Problem

A material testing machine according to a first aspect of the present invention is a material testing machine that executes a material test for measuring the mechanical properties of a specimen by applying a load to the specimen, the material testing machine comprising: a load mechanism that applies a load to the specimen; an output unit that generates a sinusoidal input waveform indicating a target value of the load and outputs an instruction signal to the load mechanism based on the target value; a detection unit that detects the load applied to the specimen by the load mechanism; and a calculation unit that calculates a distortion rate of an output waveform indicating a detection result of the detection unit during execution of the material test.

A control method for a material testing machine according to a second aspect of the present invention is a control method for a material testing machine that includes a load mechanism for applying a load to a specimen and executes a material test for measuring the mechanical properties of the specimen, the method comprising: an output step of generating a sinusoidal input waveform indicating a target value of the load and outputting an instruction signal to the load mechanism based on the target value; a detection step of detecting the load applied to the specimen by the load mechanism; and a calculation step of calculating a distortion rate of an output waveform indicating a detection result in the detection step during execution of the material test.

### Effects of the Invention

The material testing machine according to the first aspect of the present invention and the control method for a material testing machine according to the second aspect of the present invention calculate the distortion rate of the output waveform during the execution of a material test.

Therefore, during the execution of a material test, the degree of deviation of the output waveform from a sine wave can be quantitatively grasped.

### BRIEF DESCRIPTION OF DRAWINGS

FIG. 1 is a diagram showing an example of the configuration of a fatigue testing machine according to the present embodiment.

FIG. 2 is a diagram showing an example of the configuration of a main body control device.

FIG. 3 is a screen diagram showing an example of a distortion rate display screen.

FIG. 4 is a screen diagram showing another example of a distortion rate display screen.

FIG. 5 is a flowchart showing an example of processing by the main body control device.

### DESCRIPTION OF EMBODIMENTS

First, the circumstances that led the inventors to identify the above-mentioned “Problem to be Solved by the Invention” will be described below.

In a feedback system used for controlling a material testing machine, there is a deviation between the input waveform, which is the target waveform, and the output waveform, which is the detected waveform. For example, the output waveform has a delay (phase difference) with respect to the input waveform. Also, for example, when the input waveform is a sine wave, the output waveform becomes a waveform that deviates from a sine wave.

In conventional applications of material testing machines, it was not known that there were demands from users regarding the degree of deviation of the output waveform from a sine wave.

However, the inventors have recognized that there is a demand to check even the degree of deviation of the output waveform from a sine wave, which was conventionally ignored, for example, in the field of dynamic characteristic tests of shock absorbers and the like. This is because, in the field of dynamic characteristic tests of shock absorbers and the like, the influence of the degree of deviation of the output waveform from a sine wave on the test results cannot be ignored.

Meanwhile, in order to evaluate the degree of deviation of the output waveform from a sine wave, it is conceivable to display the input waveform and the output waveform on a single screen, for example, with time as the horizontal axis. With this method, the degree of deviation of the output waveform from a sine wave can be judged to some extent visually. However, in the feedback system used for controlling a material testing machine, a delay (phase difference) occurs between the input waveform and the output waveform, making accurate visual judgment difficult.

To solve the above problem, it is required to quantitatively evaluate the degree of deviation of the output waveform from a sine wave even in the feedback system used for controlling a material testing machine. The inventors have found that calculating the “distortion rate” of the output waveform can be used as a method for quantitatively evaluating the degree of deviation of the output waveform from a sine wave. The “distortion rate” has conventionally been used for evaluating the characteristics of electric circuits such as amplifier circuits, but there was no idea of applying it to a material testing machine.

Hereinafter, the present embodiment will be described with reference to the drawings.

### [1. Configuration of Fatigue Testing Machine]

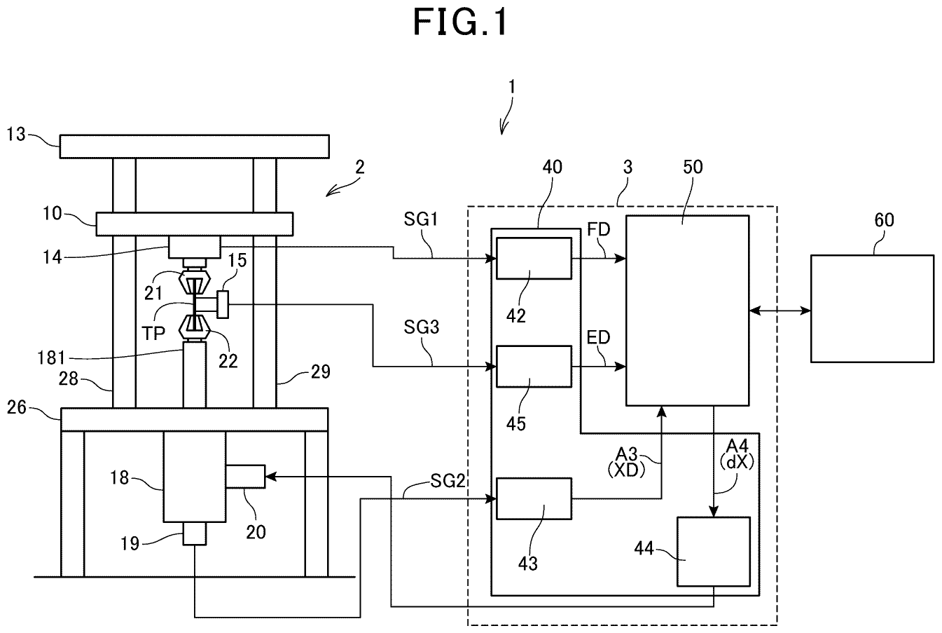

FIG. 1 is a diagram showing an example of the configuration of a fatigue testing machine 1 according to the present embodiment.

The fatigue testing machine 1 of the present embodiment performs a fatigue test to measure the mechanical properties of a sample by repeatedly applying a test force F to a test piece TP. The test force F is, for example, a tensile force.

The fatigue testing machine 1 includes a testing machine main body 2 that performs a fatigue test by repeatedly applying a test force F to a test piece TP, which is the material to be tested, a control unit 3 that controls the fatigue test operation by the testing machine main body 2, and a display mechanism 60.

The test force F corresponds to an example of a “load”.

The test piece TP corresponds to an example of a “specimen”.

The fatigue testing machine 1 corresponds to an example of a “material testing machine”.

As shown in FIG. 1, the testing machine main body 2 is configured with a load frame formed by a pair of columns 28, 29 and a yoke 13 on a base 26, and a crosshead 10 is fixed to the columns 28, 29.

A hydraulic actuator 18 is disposed on the base 26, and a lower grip 22 for gripping the lower end of the test piece TP is attached to a piston rod 181 of the hydraulic actuator 18. An upper grip 21 for gripping the upper end of the test piece TP is attached to the crosshead 10 via a load cell 14.

In the hydraulic actuator 18, the direction and amount of hydraulic oil are controlled by a servo valve 20, causing the piston rod 181 to extend and retract. As a result, the distance between the upper grip 21 and the lower grip 22 extends and retracts, and a test force F is applied to the test piece TP fixed between the upper grip 21 and the lower grip 22. The stroke of the hydraulic actuator 18, that is, the displacement of the test piece TP, is detected by a differential transformer 19 attached to the hydraulic actuator 18. The hydraulic actuator 18 corresponds to an example of a “load mechanism”.

The load cell 14 is a sensor that measures the test force F, which is a tensile load applied to the test piece TP, and outputs a test force measurement signal SG1 to the control unit 3. The differential transformer 19 is a sensor that measures the amount of displacement of the test piece TP and outputs a displacement measurement signal SG2 corresponding to the amount of displacement to the control unit 3.

An extensometer 15 is placed on the test piece TP. The test piece TP is, for example, a dumbbell-shaped test piece with a narrowed center. The extensometer 15 measures the elongation amount E by measuring the distance between a pair of gauge marks on the test piece TP and outputs an elongation measurement signal SG3 to the control unit 3. The pair of gauge marks are placed on the upper and lower parts of the narrowed region of the test piece TP.

The control unit 3 includes a signal input/output device 40 and a main body control device 50.

The signal input/output device 40 constitutes an input/output interface circuit for transmitting and receiving signals to and from the testing machine main body 2, and in the present embodiment, it has a first sensor amplifier 42, a second sensor amplifier 43, a third sensor amplifier 45, and a servo amplifier 44.

The first sensor amplifier 42 is an amplifier that amplifies the test force measurement signal SG1 output from the load cell 14 to generate a test force detected value FD, and outputs the test force detected value FD to the main body control device 50.

The second sensor amplifier 43 amplifies the displacement measurement signal SG2 output from the differential transformer 19 and outputs a displacement measurement signal A3 indicating a displacement detected value XD to the main body control device 50 as a digital signal.

The third sensor amplifier 45 is an amplifier that amplifies the elongation measurement signal SG3 output from the extensometer 15 to generate an elongation detected value ED, and outputs the elongation detected value ED to the main body control device 50. The servo amplifier 44 is a device that controls the servo valve 20 according to the control of the main body control device 50. For example, the main body control device 50 calculates an instruction value dX based on the test force detected value FD and the test force target value TF, and transmits an instruction signal A4 indicating the instruction value dX to the servo valve 20.

The main body control device 50 controls the operation of the testing machine main body 2 based on operations from a user. The main body control device 50 also causes the testing machine main body 2 to execute a fatigue test.

In the present embodiment, the “user” includes an operator who operates the testing machine main body 2.

The main body control device 50 comprises a computer having a storage device such as an HDD (Hard Disk Drive) or SSD (Solid State Drive), an interface circuit with the signal input/output device 40, and various electronic circuits.

An A/D converter is provided in the interface circuit with the signal input/output device 40, and the analog signals of the test force measurement signal SG1, the displacement measurement signal SG2, and the elongation measurement signal SG3 are converted into digital signals by the A/D converter.

The display mechanism 60 is communicably connected to the main body control device 50 and displays various types of information. The display mechanism 60 includes a display 61 such as an LCD (Liquid Crystal Display), and the display mechanism 60 causes the display 61 to display various images.

### [2. Configuration of Main Body Control Device]

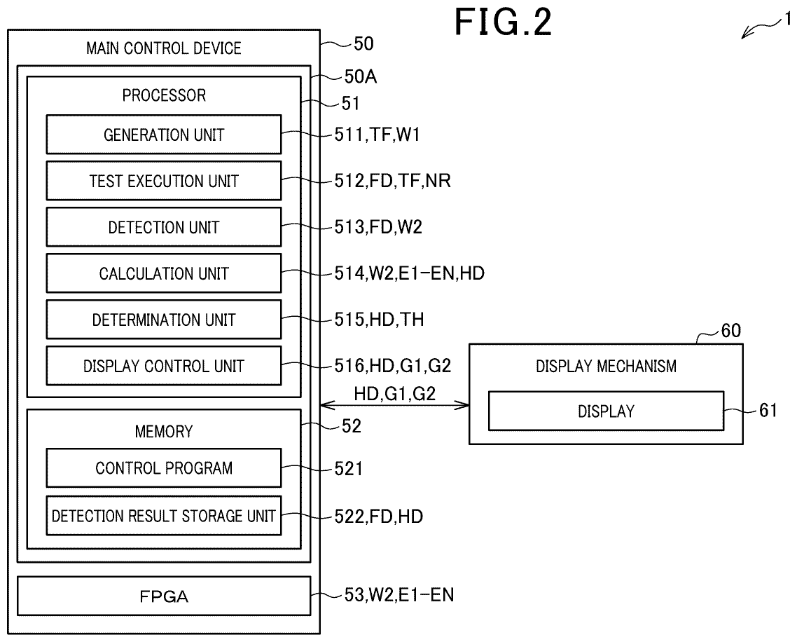

Next, the configuration of the main body control device 50 will be described with reference to FIG. 2. FIG. 2 is a diagram showing an example of the configuration of the main body control device 50 according to the present embodiment.

The main body control device 50 is configured by, for example, a personal computer. The main body control device 50 includes a control unit 50A and an FPGA (Field Programmable Gate Array) 53. The control unit 50A includes a processor 51 and a memory 52.

The processor 51 is configured by a CPU (Central Processing Unit), an MPU (Micro-Processing Unit), or the like.

The memory 52 is configured by a ROM (Read Only Memory), a RAM (Random Access Memory), or the like. The memory 52 stores a control program 521.

The main body control device 50 is not limited to a personal computer and may be configured by one or more appropriate circuits such as an IC chip or an LSI integrated circuit. The main body control device 50 may also be configured by, for example, a tablet terminal or a smartphone.

As shown in FIG. 2, the control unit 50A includes a generation unit 511, a test execution unit 512, a detection unit 513, a calculation unit 514, a determination unit 515, a display control unit 516, and a detection result storage unit 522.

Specifically, the processor 51 functions as the generation unit 511, the test execution unit 512, the detection unit 513, the calculation unit 514, the determination unit 515, and the display control unit 516 by executing the control program 521 stored in the memory 52. Further, the processor 51 causes the memory 52 to function as the detection result storage unit 522 by executing the control program 521 stored in the memory 52.

The detection result storage unit 522 stores the test force detected value FD and the distortion rate HD in association with each other.

The test force detected value FD is detected by the detection unit 513 and stored in the detection result storage unit 522 by the detection unit 513.

The distortion rate HD is calculated by the calculation unit 514 and stored in the detection result storage unit 522 by the calculation unit 514.

The generation unit 511 generates a sinusoidal input waveform W1 indicating a test force target value TF, which is a target value of the test force F. The generation unit 511 may also generate a sinusoidal input waveform W1 indicating an elongation target value TE, which is a target value of the elongation E. Further, the generation unit 511 may generate a sinusoidal input waveform W1 indicating a displacement target value, which is a target value of the displacement amount.

The test execution unit 512 executes a fatigue test.

The test execution unit 512 controls the testing machine main body 2 by, for example, PID (Proportional-Integral-Differential) control so that, for example, the test force detected value FD matches the test force target value TF.

For example, the test execution unit 512 controls the hydraulic actuator 18 so that the test force F becomes the test force target value TF based on the test force detected value FD. In other words, the test execution unit 512 calculates an instruction value dX based on the test force detected value FD and the test force target value TF, and transmits an instruction signal A4 indicating the instruction value dX to the servo valve 20 of the hydraulic actuator 18.

In the present embodiment, a case is described where the test execution unit 512 controls the hydraulic actuator 18 so that the test force detected value FD becomes the test force target value TF, but the embodiment is not limited to this. The test execution unit 512 may control the hydraulic actuator 18 so that the elongation detected value ED becomes an elongation target value TE, which is the target value of the elongation E. Also, the test execution unit 512 may control the hydraulic actuator 18 so that the displacement detected value XD becomes a displacement target value, which is the target value of the displacement amount.

The test execution unit 512 terminates the execution of the fatigue test by the testing machine main body 2 when the test force F corresponding to the number of repetitions NR specified in the test conditions has been applied to the test piece TP. The number of repetitions NR is the number of times the test force F is repeatedly applied. The number of repetitions NR is, for example, 10\hat{ }3 to 10\hat{ }8 times. One repetition of the number of repetitions NR corresponds to the change in the test force F over one period W of the input waveform W1.

Further, the test execution unit 512 terminates the execution of the fatigue test by the testing machine main body 2 if the test piece TP fractures during the period when the test force F corresponding to the number of repetitions NR specified in the test conditions is being applied to the test piece TP.

The detection unit 513 acquires the test force detected value FD. The test force detected value FD is a detected value of the test force F that the testing machine main body 2 applies to the test piece TP. The detection unit 513 acquires the test force detected value FD output from the load cell 14 via the first sensor amplifier 42.

The calculation unit 514 calculates the distortion rate HD of the output waveform W2, which indicates the detection result of the detection unit 513, while the testing machine main body 2 is executing a fatigue test. The output waveform W2 is, for example, the output waveform W2 of the test force detected value FD.

The calculation unit 514 performs an FFT (Fast Fourier Transform) on the output waveform W2 of the test force detected value FD to calculate the distortion rate HD.

The calculation unit 514, for example, calculates the distortion rate HD each time the detection unit 513 detects an output waveform W2 corresponding to one period W of the sine wave. In this case, the calculation unit 514 generates a virtual output waveform W2 by repeating the output waveform W2 corresponding to one period W of the sine wave a number of times corresponding to a predetermined number M. Then, the calculation unit 514 performs an FFT on the virtual output waveform W2 to calculate the distortion rate HD. The predetermined number M is, for example, 100.

In this case, the distortion rate HD can be calculated accurately, and the distortion rate HD can be calculated frequently.

Further, the calculation unit 514 may, for example, calculate the distortion rate HD each time the detection unit 513 detects an output waveform W2 corresponding to a predetermined number M of periods W. The predetermined number Mis, for example, 10. The predetermined number M may also be, for example, 100.

The larger the predetermined number M, the more accurately the distortion rate HD can be calculated. The smaller the predetermined number M, the more frequently the distortion rate HD can be calculated.

The calculation unit 514 causes the FPGA 53 to execute an FFT to calculate the effective values of the fundamental wave and harmonics of the output waveform W2 of the test force detected value FD. Further, the calculation unit 514 calculates the distortion rate HD by the following formula (1).

$$HD = {( E {2}^{2} + E {3}^{2} + … + {EN}^{2} )}^{1 / 2} / E 1 \times 100 \qquad ( 1 )$$

The effective value E1 indicates the effective value of the fundamental wave. The effective value E2 indicates the effective value of the 2nd harmonic. The effective value E3 indicates the effective value of the 3rd harmonic. The effective value EN indicates the effective value of the Nth harmonic. The coefficient N is, for example, a value from 10 to 100.

The FPGA 53 constitutes a part of the calculation unit 514.

The FPGA 53 corresponds to an example of a “PLD (Programmable Logic Device)”.

The determination unit 515 determines that the control accuracy of the hydraulic actuator 18 is poor when the distortion rate HD is equal to or greater than a preset threshold value TH. The threshold value TH is, for example, 5%. The threshold value TH may also be, for example, 10%.

The threshold value TH is set, for example, according to the control accuracy required by the user.

The display control unit 516 displays the distortion rate HD on the display 61 during the execution of a fatigue test. Further, each time the calculation unit 514 calculates the distortion rate HD, the display control unit 516 updates the distortion rate HD displayed on the display 61.

Further, the display control unit 516 displays the input waveform W1 and the output waveform W2 as graphs on the display 61. Further, the display control unit 516 displays the determination result of the determination unit 515 on the display 61.

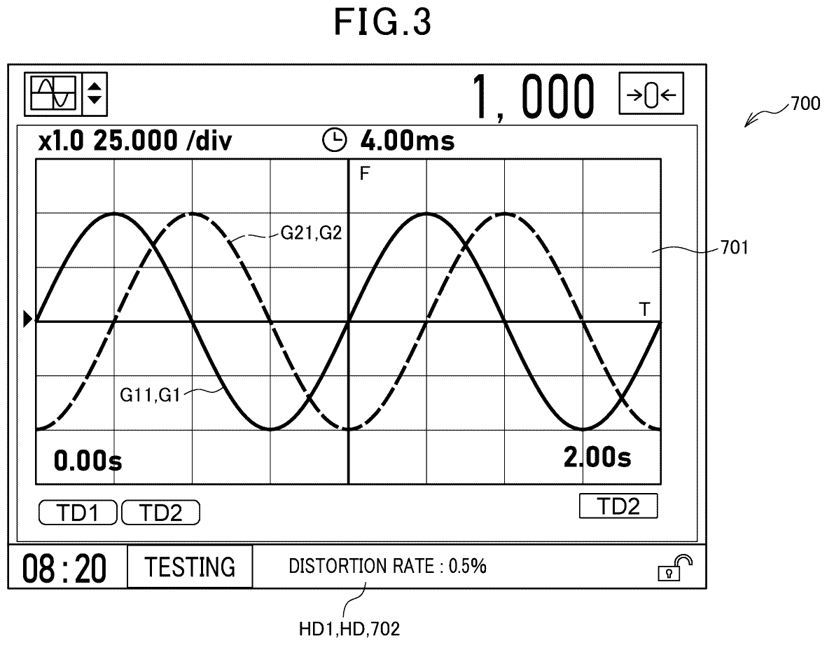

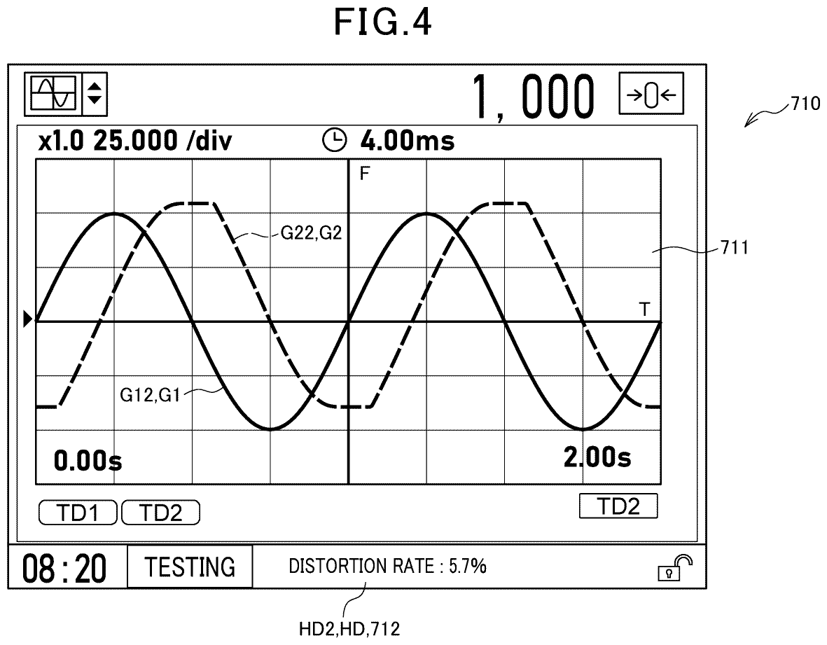

The distortion rate HD, the input waveform W1, and the output waveform W2 will be further described with reference to FIG. 3 and FIG. 4.

### [3. Display Screen]

Next, the distortion rate display screen displayed on the display 61 by the display control unit 516 will be described with reference to FIGS. 3-4. FIG. 3 is a screen diagram showing an example of a distortion rate display screen 700. The distortion rate display screen 700 is displayed on the display 61 of the display mechanism 60 by the display control unit 516, for example. In FIG. 3, for example, the distortion rate HD is 0.5%.

As shown in FIG. 3, the distortion rate display screen 700 includes a graph display section 701 and a distortion rate display section 702.

A graph G11 and a graph G21 are displayed in the graph display section 701. The graph G11 corresponds to an example of a graph G1 showing the input waveform W1. The graph G21 corresponds to an example of a graph G2 showing the output waveform W2.

In the graph display section 701, time T is displayed as the horizontal axis for the graph G11 and the graph G21. In the graph display section 701, the test force F is displayed as the vertical axis for the graph G11 and the graph G21.

As shown in the graph G11, the input waveform W1 is a sine wave. As shown in the graph G21, the output waveform W2 is a waveform that approximates a sine wave.

The display control unit 516 updates the graph G11 and the graph G21 at predetermined time intervals. The predetermined time is, for example, 1 second.

The distortion rate display section 702 displays the most recent distortion rate HD calculated by the calculation unit 514. The distortion rate display section 702 displays “Distortion rate: 0.5%”, and the most recent distortion rate HD1 is “0.5%”.

In the present embodiment, the calculation unit 514, for example, calculates the distortion rate HD each time the detection unit 513 detects an output waveform W2 corresponding to one period W of a sine wave. Therefore, the distortion rate HD1 displayed in the distortion rate display section 702 indicates the distortion rate HD of the output waveform W2 for one period W on the right side of the graph G21 shown in FIG. 3.

FIG. 4 is a screen diagram showing another example of a distortion rate display screen 710. The distortion rate display screen 710 is displayed on the display 61 of the display mechanism 60 by the display control unit 516, for example. In FIG. 4, for example, the distortion rate HD is 5.7%.

As shown in FIG. 4, the distortion rate display screen 710 includes a graph display section 711 and a distortion rate display section 712.

A graph G12 and a graph G22 are displayed in the graph display section 711. The graph G12 corresponds to an example of a graph G1 showing the input waveform W1. The graph G22 corresponds to an example of a graph G2 showing the output waveform W2.

In the graph display section 711, time T is displayed as the horizontal axis for the graph G12 and the graph G22. In the graph display section 711, the test force F is displayed as the vertical axis for the graph G12 and the graph G22.

As shown in the graph G12, the input waveform W1 is a sine wave. As shown in the graph G22, the output waveform W2 is a waveform with a larger deviation from a sine wave compared to the output waveform W2 shown by the graph G21 in FIG. 3.

The display control unit 516 updates the graph G12 and the graph G22 at predetermined time intervals. The predetermined time is, for example, 1 second.

The distortion rate display section 712 displays the most recent distortion rate HD calculated by the calculation unit 514. The distortion rate display section 702 displays “Distortion rate: 5.7%”, and the most recent distortion rate HD2 is “5.7%”.

In the present embodiment, the calculation unit 514, for example, calculates the distortion rate HD each time the detection unit 513 detects an output waveform W2 corresponding to one period W of a sine wave. Therefore, the distortion rate HD2 displayed in the distortion rate display section 712 indicates the distortion rate HD of the output waveform W2 for one period W on the right side of the graph G22 shown in FIG. 4.

When the threshold value TH is, for example, 5%, the determination unit 515 determines that the control accuracy of the hydraulic actuator 18 is poor. As described above, in FIG. 4, since the distortion rate HD is 5.7%, the determination unit 515 determines that the control accuracy of the hydraulic actuator 18 is poor. Therefore, the display control unit 516, for example, flashes the text image “Distortion rate: 5.7%” in red.

### [4. Processing of Main Body Control Device]

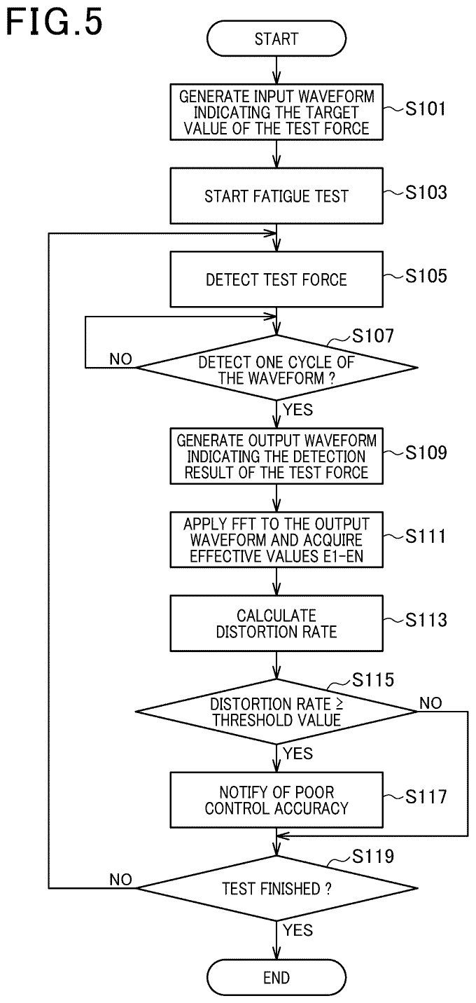

Next, the processing executed by the main body control device 50 will be described with reference to FIG. 5. FIG. 5 is a flowchart showing an example of the processing of the main body control device 50.

As shown in FIG. 5, first, in step S101, the generation unit 511 generates a sinusoidal input waveform W1 indicating a test force target value TF, which is the target value of the test force F.

Next, in step S103, the test execution unit 512 starts a fatigue test. The test execution unit 512 starts the fatigue test, for example, based on an operation from the user.

Next, in step S105, the detection unit 513 acquires the test force detected value FD output from the load cell 14 via the first sensor amplifier 42. Further, the display control unit 516 displays the input waveform W1 and the output waveform W2 on the display 61.

Next, in step S107, the calculation unit 514 determines whether the detection unit 513 has detected an output waveform W2 corresponding to one period W of a sine wave.

If the calculation unit 514 determines that the detection unit 513 has not detected an output waveform W2 corresponding to one period W of the sine wave (step S107; NO), the process enters a standby state. If the calculation unit 514 determines that the detection unit 513 has detected an output waveform W2 corresponding to one period W of the sine wave (step S107; YES), the process proceeds to step S109.

Then, in step S109, the calculation unit 514 generates a virtual output waveform W2 by repeating the output waveform W2 corresponding to one period W of the sine wave a number of times corresponding to a predetermined number M.

Next, in step S111, the calculation unit 514 causes the FPGA 53 to execute an FFT on the virtual output waveform W2 to acquire the effective values E1 to EN of the fundamental wave and harmonics of the output waveform W2.

Next, in step S113, the calculation unit 514 calculates the distortion rate HD from the effective values E1 to EN of the fundamental wave and harmonics of the output waveform W2. The display control unit 516 displays the distortion rate HD on the display 61.

Next, in step S115, the determination unit 515 determines whether the distortion rate HD is equal to or greater than a preset threshold value TH.

If the determination unit 515 determines that the distortion rate HD is not equal to or greater than the threshold value TH (step S115; NO), the process proceeds to step S119. If the determination unit 515 determines that the distortion rate HD is equal to or greater than the threshold value TH (step S115; YES), the process proceeds to step S117.

Then, in step S117, the determination unit 515 determines that the control accuracy of the hydraulic actuator 18 is poor. Then, the display control unit 516 issues a notification that the control accuracy of the hydraulic actuator 18 is poor. For example, the display control unit 516 flashes the distortion rate HD in red on the display 61.

Next, in step S119, the test execution unit 512 determines whether to terminate the execution of the fatigue test.

If the test execution unit 512 determines not to terminate the execution of the fatigue test (step S119; NO), the process returns to step S105. If the test execution unit 512 determines to terminate the execution of the fatigue test (step S119; YES), the process is then terminated.

Step S101 corresponds to an example of a “generation step”.

Step S105 corresponds to an example of a “detection step”.

Steps S109, S111, and S113 correspond to an example of a “calculation step”.

### 5. Aspects and Effects

It will be understood by those skilled in the art that the above-described embodiment is a specific example of the following aspects.

### (Aspect 1)

A material testing machine according to this embodiment is a material testing machine that executes a material test for measuring the mechanical properties of a specimen by applying a load to the specimen, the material testing machine comprising: a load mechanism that applies a load to the specimen; a generation unit that generates a sinusoidal input waveform indicating a target value of the load; a detection unit that detects the load applied to the specimen by the load mechanism; and a calculation unit that calculates a distortion rate of an output waveform indicating a detection result of the detection unit during execution of the material test.

According to the material testing machine of Aspect 1, the distortion rate of the output waveform is calculated during the execution of a material test.

Therefore, during the execution of a material test, the user can quantitatively grasp the degree of deviation of the output waveform from a sine wave based on the distortion rate of the output waveform. Accordingly, the convenience for the user can be improved.

### (Aspect 2)

In the material testing machine according to Aspect 1, the calculation unit performs an FFT on the output waveform to calculate the distortion rate.

According to the material testing machine of Aspect 2, an FFT is performed on the output waveform to calculate the distortion rate.

Therefore, the distortion rate can be calculated appropriately. Accordingly, the user can quantitatively and appropriately grasp the degree of deviation of the output waveform from a sine wave.

### (Aspect 3)

In the material testing machine according to Aspect 2, the calculation unit comprises a PLD, and the PLD performs the FFT on the output waveform.

According to the material testing machine of Aspect 3, the calculation unit comprises a PLD, and the PLD performs the FFT on the output waveform.

Therefore, since the PLD performs the FFT on the output waveform, the FFT processing of the output waveform can be executed in a shorter time compared to the case where the FFT is executed by software. Accordingly, the distortion rate can be appropriately calculated during the execution of a material test. As a result, the distortion rate can be calculated in substantially real time.

### (Aspect 4)

In the material testing machine according to any one of Aspects 1 to 3, the material test is a fatigue test, and the material testing machine comprises a display control unit that displays the distortion rate on a display during execution of the fatigue test.

According to the material testing machine of Aspect 4, the distortion rate is displayed on the display during the execution of the fatigue test.

Therefore, the user can visually confirm the distortion rate of the output waveform during the execution of the fatigue test. Accordingly, the distortion rate of the output waveform can be easily grasped. As a result, the convenience for the user can be improved.

### (Aspect 5)

In the material testing machine according to Aspect 4, each time the calculation unit calculates the distortion rate, the display control unit updates the distortion rate displayed on the display.

According to the material testing machine of Aspect 5, each time the calculation unit calculates the distortion rate, the display control unit updates the distortion rate displayed on the display.

Therefore, the distortion rate displayed on the display can be updated as frequently as possible. Accordingly, the user can visually confirm the distortion rate of the output waveform in substantially real time.

### (Aspect 6)

In the material testing machine according to Aspect 4, the display control unit displays the input waveform and the output waveform as graphs on the display.

According to the material testing machine of Aspect 6, the display control unit displays the input waveform and the output waveform as graphs on the display.

Therefore, the user can compare the graph of the input waveform and the graph of the output waveform with the distortion rate of the output waveform. Accordingly, the user can compare the degree of deviation of the graph of the output waveform from a sine wave with the distortion rate of the output waveform.

### (Aspect 7)

The material testing machine according to Aspect 4 comprises a determination unit that determines that the control accuracy of the load mechanism is poor when the distortion rate is equal to or greater than a preset threshold value, wherein the display control unit displays a determination result of the determination unit on the display.

According to the material testing machine of Aspect 7, when the distortion rate is equal to or greater than a preset threshold value, it is determined that the control accuracy of the load mechanism is poor, and the determination result is displayed on the display. Therefore, by setting the threshold value to an appropriate value, it can be appropriately determined whether the control accuracy of the load mechanism is poor. Further, since the determination result is displayed on the display, the user can visually confirm whether the control accuracy of the load mechanism is poor. Accordingly, the convenience for the user can be improved.

### (Aspect 8)

A control method for a material testing machine according to this embodiment is a control method for a material testing machine that includes a load mechanism for applying a load to a specimen and executes a material test for measuring the mechanical properties of the specimen, the method comprising: a generation step of generating a sinusoidal input waveform indicating a target value of the load; a detection step of detecting the load applied to the specimen by the load mechanism; and a calculation step of calculating a distortion rate of an output waveform indicating a detection result in the detection step during execution of the material test.

The display control method for a material testing machine according to Aspect 8 provides the same operational effects as the material testing machine according to Aspect 1.

### 6. Other Embodiments

The fatigue testing machine 1 according to the present embodiment is merely an example of an aspect of the material testing machine according to the present invention, and can be arbitrarily modified and applied without departing from the gist of the present invention.

In the present embodiment, the case where the material testing machine is the fatigue testing machine 1 has been described, but the embodiment is not limited to this. It is sufficient that the material testing machine executes a material test for measuring the mechanical properties of a specimen by applying a load to the specimen. For example, the material testing machine may be a tensile testing machine, a compression testing machine, a bending testing machine, or a torsion testing machine.

Further, in the present embodiment, the case where the load applied by the fatigue testing machine 1 to the test piece TP is the test force F has been described, but the embodiment is not limited to this. The load applied by the fatigue testing machine 1 to the test piece TP may be, for example, the elongation E of the test piece TP, or the displacement of the test piece TP.

Further, in the present embodiment, the case where the specimen is the test piece TP has been described, but the embodiment is not limited to this. The specimen may be, for example, a vehicle component such as a shock absorber.

Further, in the present embodiment, the case where the fatigue testing machine 1 includes the main body control device 50 and the display mechanism 60 as separate bodies has been described, but the embodiment is not limited to this. For example, the main body control device 50 and the display mechanism 60 may be configured integrally.

Further, in the present embodiment, the case where the main body control device 50 includes the generation unit 511, the test execution unit 512, the detection unit 513, the calculation unit 514, the determination unit 515, the display control unit 516, and the detection result storage unit 522 has been described, but the embodiment is not limited to this. For example, the display mechanism 60 may include at least one of the generation unit 511, the test execution unit 512, the detection unit 513, the calculation unit 514, the determination unit 515, the display control unit 516, and the detection result storage unit 522. For example, the display mechanism 60 may include the display control unit 516.

In the present embodiment, the case where the main body control device 50 includes an FPGA has been described, but the embodiment is not limited to this. It is sufficient that the main body control device 50 includes, for example, a PLD (Programmable Logic Device). The main body control device 50 may include, for example, a CPLD (Complex Programmable Logic Device), or the main body control device 50 may include, for example, a SoC (System-on-a-Chip)-FPGA.

Further, the functional blocks shown in FIG. 2 indicate a functional configuration, and the specific implementation form is not particularly limited. That is, it is not always necessary to implement hardware corresponding to each functional block individually, and it is of course possible to adopt a configuration in which a single processor realizes the functions of a plurality of functional blocks by executing a program. Further, a part of the functions realized by software in the above-described embodiment may be realized by hardware, or a part of the functions realized by hardware may be realized by software.

Further, the processing units of the flowchart shown in FIG. 5 are divided according to the main processing contents to facilitate understanding of the processing of the main body control device 50. The present invention is not limited by the way of dividing the processing units or the names thereof shown in the flowchart of FIG. 5, and it is possible to divide into more processing units or to divide so that one processing unit includes more processing, depending on the processing content. The processing order of the above flowchart is also not limited to the illustrated example.

Further, as described with reference to FIG. 2, in the present embodiment, the processor 51 included in the main body control device 50 is caused to execute the control program 521 stored in the memory 52. This control program 521 can also be recorded on a computer-readable recording medium. As the recording medium, a magnetic or optical recording medium or a semiconductor memory device can be used.

Specifically, portable or fixed recording media such as a flexible disk, HDD, CD-ROM (Compact Disc Read Only Memory), DVD, Blu-ray (registered trademark) Disc, magneto-optical disk, flash memory, and card-type recording medium can be mentioned. The recording medium may also be a non-volatile storage device such as a RAM, ROM, or HDD, which is an internal storage device included in the main body control device 50. Further, the control program 521 may be stored in a server device or the like, and the control program 521 may be downloaded from the server device to the main body control device 50.

### REFERENCE SIGNS LIST

1 Fatigue testing machine (Material testing machine)
2 Testing machine main body
3 Control unit
14 Load cell
15 Extensometer
18 Hydraulic actuator (Load mechanism)
19 Differential transformer
20 Servo valve
40 Signal input/output device
50 Main body control device
50A Control unit
51 Processor
511 Generation unit
512 Test execution unit
513 Detection unit
514 Calculation unit
515 Determination unit
52 Memory
521 Control program
522 Detection result storage unit
53 FPGA (Part of calculation unit, PLD)
60 Display mechanism
61 Display
E1-EN Effective value
F Test force (Load)
FD Test force detected value
G1, G11, G12 Graph
HD, HD1, HD2 Distortion rate
SG1 Test force measurement signal
TF Test force target value
TH Threshold value
TP Test piece (Specimen)
W1 Input waveform
W2 Output waveform

1. A material testing machine that executes a material test for measuring a mechanical property of a specimen by applying a load to the specimen, the material testing machine comprising:
a load mechanism that applies a load to the specimen;
a generation unit that generates a sinusoidal input waveform indicating a target value of the load;
a detection unit that detects the load applied to the specimen by the load mechanism; and
a calculation unit that calculates a distortion rate of an output waveform indicating a detection result of the detection unit during execution of the material test.

2. The material testing machine according to claim 1, wherein
the calculation unit performs an FFT on the output waveform to calculate the distortion rate.

3. The material testing machine according to claim 2, wherein
the calculation unit comprises a PLD, and
the PLD performs the FFT on the output waveform.

4. The material testing machine according to claim 1, wherein
the material test is a fatigue test, and
the material testing machine comprises a display control unit that displays the distortion rate on a display during execution of the fatigue test.

5. The material testing machine according to claim 4, wherein
each time the calculation unit calculates the distortion rate, the display control unit updates the distortion rate displayed on the display.

6. The material testing machine according to claim 4, wherein
the display control unit displays the input waveform and the output waveform as graphs on the display.

7. The material testing machine according to claim 4, comprising
a determination unit that determines that a control accuracy of the load mechanism is poor when the distortion rate is equal to or greater than a preset threshold value, wherein
the display control unit displays a determination result of the determination unit on the display.

8. A control method for a material testing machine that includes a load mechanism for applying a load to a specimen and executes a material test for measuring a mechanical property of the specimen, the method comprising:
a generation step of generating a sinusoidal input waveform indicating a target value of the load;
a detection step of detecting the load applied to the specimen by the load mechanism; and
a calculation step of calculating a distortion rate of an output waveform indicating a detection result in the detection step during execution of the material test.
